(19) United States
(12) Patent Application Publication
(10) Pub. No.: US 2025/0109943 A1
(43) Pub. Date: Apr. 3, 2025

(54) POSITION MEASUREMENT APPARATUS, POSITION MEASUREMENT METHOD, PROGRAM, AND STORAGE DEVICE

(71) Applicant: HONDA MOTOR CO., LTD., Tokyo (JP)

(72) Inventor: Futoshi Aiba, Wako-shi (JP)

(21) Appl. No.: 18/895,820

(22) Filed: Sep. 25, 2024

(30) Foreign Application Priority Data
Sep. 28, 2023 (JP) 2023-166709

(51) Int. Cl. G01C 21/16

(52) U.S. Cl. CPC G01C 21/165

(57) ABSTRACT

A position measurement apparatus includes a first position estimation portion, a second position estimation portion, and an information integration portion. The first position estimation portion and the second position estimation portion output first information and second information based on a position measurement in each of different coordinate systems (a world geographical coordinate system and a map coordinate system). The information integration portion performs a predetermined optimization process on a combination of the first information and the second information that are recognized as information at the same time. The information integration portion acquires a difference (inter-coordinate difference) relating to information of a position, an attitude and the like of a movable body between the different coordinate systems from each other of the first information and the second information by a predetermined optimization process.

### CROSS-REFERENCE TO RELATED APPLICATION

Priority is claimed on Japanese Patent Application No. 2023-166709, filed on Sep. 28, 2023, the contents of which are incorporated herein by reference.

### BACKGROUND

### Field of the Invention

The present invention relates to a position measurement apparatus, a position measurement method, a program, and a storage device.

### Background

In the related art, for example, a system is known which controls automatic travel of a movable body by a position of the movable body based on a position measurement signal acquired from a satellite and a position of the movable body based on point group data acquired from a ranging sensor (for example, refer to Japanese Unexamined Patent Application, First Publication No. 2022-146457).

### SUMMARY

In the system of the related art described above, the increase in a process load and electric power consumption is prevented by switching a satellite position measurement and a scan matching in accordance with a travel region. However, each of a coordinate system in the satellite position measurement and a coordinate system in the scan matching is different from each other and has a non-uniform error, and thereby, a problem arises in that it is impossible to ensure a desired position accuracy, and it becomes difficult to perform appropriate switching.

An aspect of the present invention aims to provide a position measurement apparatus, a position measurement method, a program, and a storage device capable of improving a position measurement accuracy.

A position measurement apparatus according to a first aspect of the present invention includes: a plurality of different position measurement portions that output position information of a movable body based on a position measurement in each of a plurality of different coordinate systems; and a process portion that acquires a difference relating to the position information between the plurality of different coordinate systems based on a combination of the position information corresponding to a predetermined time among the position information output from the plurality of different position measurement portions and acquires position information of the movable body in a predetermined reference coordinate system by correcting the difference.

A second aspect is the position measurement apparatus according to the first aspect described above which may include: an inertial navigation process portion that processes inertial navigation based on inertia information output from an inertia detection portion provided on the movable body, wherein the process portion may correct a position difference caused by a time difference from the predetermined time in the position information corresponding to the predetermined time by the inertial navigation by the inertial navigation process portion.

A third aspect is the position measurement apparatus according to the second aspect described above, wherein the plurality of different position measurement portions may include a first position measurement portion and a second position measurement portion, the first position measurement portion may output the position information by a position measurement based on a position measurement signal acquired from the outside, the second position measurement portion may output the position information by a position measurement based on point group information obtained in accordance with detection of an external object, and the process portion may set the coordinate system of the second position measurement portion to the predetermined reference coordinate system.

A fourth aspect is the position measurement apparatus according to the third aspect described above, wherein the second position measurement portion may generate a map by the point group information at least in a region where the position measurement by the first position measurement portion is not performed.

A position measurement method according to a fifth aspect of the present invention is a position measurement method executed by an electronic device including a process part that acquires position information of a movable body, the position measurement method including: outputting position information of the movable body by a position measurement in each of a plurality of different coordinate systems; and acquiring a difference relating to the position information between the plurality of different coordinate systems based on a combination of the position information corresponding to a predetermined time among the output position information and acquiring position information of the movable body in a predetermined reference coordinate system by correcting the difference.

A sixth aspect of the present invention is a computer-readable non-transitory recording medium that includes a program causing a computer of an electronic device including a process part that acquires position information of a movable body to execute: outputting position information of the movable body by a position measurement in each of a plurality of different coordinate systems; and acquiring a difference relating to the position information between the plurality of different coordinate systems based on a combination of the position information corresponding to a predetermined time among the output position information and acquiring position information of the movable body in a predetermined reference coordinate system by correcting the difference.

A storage device according to a seventh aspect of the present invention is a computer-readable storage device that stores the program according to the sixth aspect described above.

According to the first aspect described above, by including the process portion that corrects the difference between the different coordinate systems of the plurality of position measurement portions, even when non-uniform distortion is present in each coordinate system, it is possible to perform appropriate coordinate conversion, and it is possible to acquire the position information of the movable body with high accuracy.

In the case of the second aspect described above, by including the process portion that corrects, with respect to the combination of the position information corresponding to the predetermined time, the position difference caused by the time difference from the predetermined time by the inertial navigation, even when the position information output from the plurality of position measurement portions is asynchronous, it is possible to cause the position information to appropriately correspond with respect to the time.

In the case of the third aspect described above, the process portion sets the coordinate system of the second position measurement portion to the predetermined reference coordinate system, and thereby, for example, even when an accuracy decrease, reception difficulty, or the like of the position measurement signal occurs depending on the motion environment of the movable body, it is possible to acquire the position information of the movable body with high accuracy.

In the case of the fourth aspect described above, by including the second position measurement portion that generates the map by the point group information at least in the region where the position measurement by the first position measurement portion is not performed, for example, even when the operation of the second position measurement portion becomes complicated or complex in response to a frequent change or the like of the motion environment of the movable body, it is possible to reduce a dependence degree on the second position measurement portion.

According to the fifth, sixth, or seventh aspect described above, by correcting the difference between the plurality of different coordinate systems, when improving robustness with respect to the motion environment of the movable body in a plurality of different position measurements, even when non-uniform distortion is present in each coordinate system, it is possible to perform appropriate coordinate conversion, and it is possible to acquire the position information of the movable body with high accuracy.

### BRIEF DESCRIPTION OF THE DRAWINGS

FIG. 1 is a block diagram showing a functional configuration of a position measurement system including a position measurement apparatus of an embodiment of the present invention.

FIG. 2 is a view showing an example of a pose graph formed by the position measurement apparatus of the embodiment of the present invention.

FIG. 3 is a flowchart showing an operation of the position measurement apparatus in the embodiment of the present invention.

FIG. 4 is a view schematically showing an example of an optimization process by the position measurement apparatus of the embodiment of the present invention.

### DESCRIPTION OF EMBODIMENTS

Hereinafter, a position measurement apparatus and a position measurement method according to an embodiment of the present invention will be described with reference to the accompanying drawings.

A position measurement apparatus of an embodiment acquires information of a position and an attitude of a movable body. The movable body is, for example, a manned or unmanned vehicle, a movable work machine performing predetermined work while moving, a robot, and the like. The movable body performs, for example, automatic or autonomous movement, movement in accordance with a manual operation (for example, a remote operation or the like) of an operator, movement in accordance with a drive operation of an occupant, or the like.

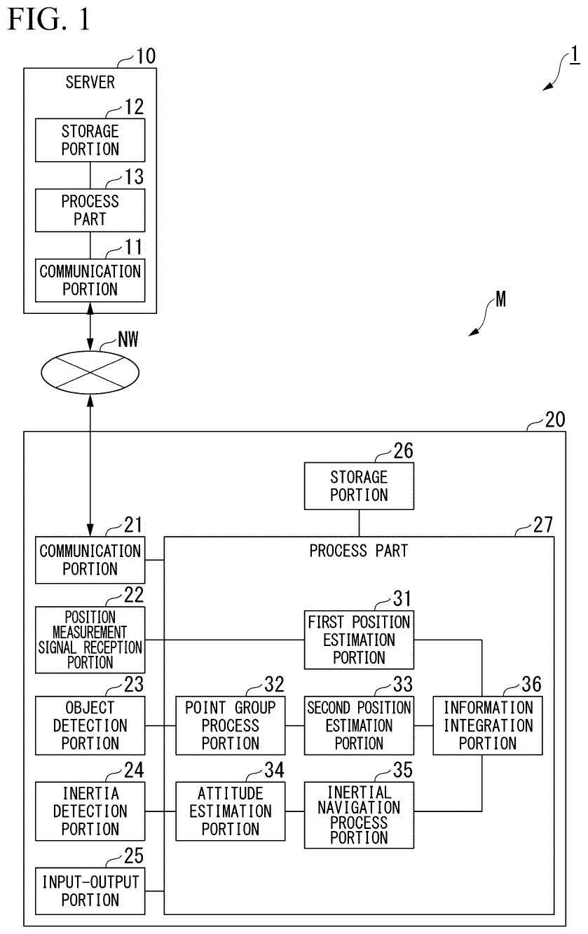

FIG. 1 is a block diagram showing a functional configuration of a position measurement system 1 including a position measurement apparatus 20 according to an embodiment.

As shown in FIG. 1, the position measurement system 1 includes, for example, a server 10 (electronic device) and the position measurement apparatus 20 (electronic device) provided on a movable body M. The server 10 and the position measurement apparatus 20 of the movable body M are connected to each other, for example, via a wired or wireless communication network NW. The communication network NW is, for example, the Internet, a mobile communication network, a LAN (Local Area Network), a WAN (Wide Area Network), and the like. For example, the LAN is a wired LAN (Local Area Network) of a predetermined standard such as Ethernet or a wireless LAN of various standards such as Wi-Fi and Bluetooth (registered trademark).

The server 10 includes, for example, a communication portion 11, a storage portion 12, and a process part 13.

The communication portion 11 performs, for example, communication with the position measurement apparatus 20 of the movable body M.

The storage portion 12 stores, for example, a variety of information, a predetermined program, and the like.

The process part 13 includes, for example, a software function unit that functions by a predetermined program being executed by a processor such as a CPU (Central Processing Unit). The software function unit is an ECU (Electronic Control Unit) that includes the processor such as a CPU, a ROM (Read-Only Memory) that stores the program, a RAM (Random-Access Memory) that temporarily stores data, and an electronic circuit such as a timer. At least part of the process part 13 may be an integrated circuit such as a LSI (Large-Scale Integration).

The position measurement apparatus 20 includes, for example, a communication portion 21, a position measurement signal reception portion 22, an object detection portion 23, an inertia detection portion 24, an input-output portion 25, a storage portion 26, and a process part 27. The process part 27 includes, for example, a first position estimation portion 31 (a position measurement portion, a first position measurement portion), a point group process portion 32 (a position measurement portion, a second position measurement portion), a second position estimation portion 33 (a position measurement portion, a second position measurement portion), an attitude estimation portion 34, an inertial navigation process portion 35, and an information integration portion 36 (a process portion).

The communication portion 21 performs, for example communication with the server 10.

The position measurement signal reception portion 22 includes, for example, an antenna used for a satellite position measurement system (GNSS: Global Navigation Satellite System) such as a GPS (Global Positioning System). The position measurement signal reception portion 22 outputs, for example, predetermined information obtained from a position measurement signal received by the antenna or information of a position, an attitude, and the like obtained by a predetermined calculation based on the position measurement signal to the first position estimation portion 31.

The object detection portion 23 is, for example, a sonar, a radar device, a finder, and the like and acquires three-dimensional point group data. The finder is, for example, a LIDAR (Light Detection and Ranging or Laser Imaging Detection and Ranging).

The object detection portion 23 emits, for example, ultrasonic waves, electromagnetic waves, or light to the vicinity of a target object and detects a distance to the object, a position of the object, or the like by detecting reflection or scattering by the object. The object detection portion 23 acquires an aggregation (point group data) of points having position information, for example, by scanning with respect to the object in a three-dimensional space. The object detection portion 23 outputs the acquired point group data to the point group process portion 32.

The inertia detection portion 24 is, for example, an inertial measurement unit (IMU: Inertial Measurement Unit) or the like and detects an inertial motion of the movable body M. The inertia detection portion 24 includes, for example, an acceleration sensor that detects an acceleration of the movable body M and a gyro sensor that detects an angular speed of the movable body M. The inertia detection portion 24 outputs inertia information obtained by the detection to the attitude estimation portion 34.

The input-output portion 25 includes, for example, an input-output device as a user interface, a connection terminal connected to a variety of external devices, and the like. Examples of the input-output device include a display device such as a liquid crystal display or an organic EL (Electro Luminescence) display, an input device such as a button or a touch panel that receives an input operation by an operator's finger, a microphone for audio input, a speaker for sound output, and the like.

The storage portion 26 stores, for example, a variety of information, a predetermined program, and the like.

The process part 27 includes, for example, a software function unit that functions by a predetermined program being executed by a processor such as a CPU (Central Processing Unit). The software function unit is an ECU (Electronic Control Unit) that includes the processor such as a CPU, a ROM (Read-Only Memory) that stores the program, a RAM (Random-Access Memory) that temporarily stores data, and an electronic circuit such as a timer. At least part of the process part 27 may be an integrated circuit such as a LSI (Large-Scale Integration).

The process part 27 acquires information of a position, an attitude, and the like of the movable body M, for example, by performing a variety of calculation processes on the basis of information acquired from the communication portion 21, the position measurement signal reception portion 22, the object detection portion 23, the inertia detection portion 24, the input-output portion 25, and the storage portion 26.

The first position estimation portion 31 acquires information (first information, position information) of the position, the attitude, and the like of the movable body M by a predetermined position measurement based on the information acquired from the position measurement signal reception portion 22. The first position estimation portion 31 outputs the acquired first information to the storage portion 26, the information integration portion 36, or the like.

The point group process portion 32 performs so-called scan matching by comparing point group data acquired from the object detection portion 23 with point group data (point group map) used for reference and acquired in advance. The point group process portion 32 acquires a relative displacement (displacement of the position, the attitude, and the like) between the different point group data by the scan matching. The point group process portion 32 outputs the acquired relative displacement to the second position estimation portion 33.

The second position estimation portion 33 acquires information (second information, position information) of the position, the attitude, and the like of the movable body M by a predetermined position measurement based on the point group data and the relative displacement acquired from the point group process portion 32. The second position estimation portion 33 outputs the acquired second information to the storage portion 26, the information integration portion 36, or the like.

The attitude estimation portion 34 acquires information of the attitude of the movable body M by a predetermined calculation based on the inertia information acquired from the inertia detection portion 24 or the like. The attitude estimation portion 34 calculates an attitude angle (a roll angle and a pitch angle) and an azimuth angle (a yaw angle) of the movable body M, for example, on the basis of a three-axis acceleration and a three-axis angular speed. The attitude estimation portion 34 outputs the acquired information of the attitude to the inertial navigation process portion 35.

The inertial navigation process portion 35 acquires information (third information) of a position, a speed, an attitude, and the like of the movable body M by a predetermined inertial navigation calculation or the like based on the information of the attitude of the movable body M acquired from the attitude estimation portion 34. The inertial navigation process portion 35 outputs the acquired third information to the storage portion 26, the information integration portion 36, or the like.

The information integration portion 36 integrates, for example, information of the position, the attitude, and the like of the movable body M output from each of the first position estimation portion 31, the second position estimation portion 33, and the inertial navigation process portion 35 and thereby acquires the position information of the movable body M in a predetermined reference coordinate system.

The information integration portion 36 discriminates, for example, in advance, a region where the first information is not effective and a region where the first information is effective in a movement region of the movable body M and allows acquisition of point group data and generation of a point group map by the point group process portion 32 only in the region where the first information is not effective and part of the region where the first information is effective. The region where the first information is not effective is, for example, a region that includes a region where it is difficult to acquire the first information, a region where the error of the first information is equal to or more than a predetermined value, or the like. The information integration portion 36 integrates, for example, the first information, the second information, and the third information using only the region where the first information is not effective and the part of the region where the first information is effective.

The information integration portion 36 extracts a combination of the first information and the second information that are recognized as information at the same time, for example, from the first information output from the first position estimation portion 31 and the second information output from the second position estimation portion 33. The information at the same time is, for example, information obtained by measuring the state of the movable body M at the same time, and corresponds to that a timing at which the position measurement signal received by the position measurement signal reception portion 22 is transmitted from a satellite or the like is identical to a timing at which the object detection portion 23 acquires the point group data.

The information integration portion 36 corrects, for example, with respect to the combination of the first information and the second information recognized as the information at the same time, a difference of the position, the attitude, and the like of the movable body M caused by the difference of the timing of generation, output, or the like of each information on the basis of the third information output from the inertial navigation process portion 35. For example, when recognizing that the first information output at a predetermined time t and the second information output after a certain time a elapses from the predetermined time t are information at the same measurement timing, the information integration portion 36 corrects the difference of the position, the attitude, and the like of the movable body M corresponding to the certain time a between the first information and the second information by inertial navigation.

The information integration portion 36 sets a predetermined upper limit threshold value for a time difference between the first information and the second information that are recognized as the information at the same time such as, for example, the difference of the timing of generation, output, or the like of each information such as the certain time a described above. The information integration portion 36 prohibits, for example, the combination of the first information and the second information having a time difference larger than the predetermined upper limit threshold value from being recognized as the information at the same time.

The information integration portion 36 acquires a difference (inter-coordinate difference) relating to the information of the position, the attitude, and the like of the movable body M between different coordinate systems from each other of the first information and the second information, for example, by performing a predetermined optimization process on the combination of the first information and the second information after the correction relating to the time. The difference (inter-coordinate difference) between the different coordinate systems includes, for example, a non-uniform displacement that occurs due to distortion of each coordinate system caused by a disturbance, time elapse, and the like at the time of the measurement.

Among a coordinate system (world geographical coordinate system) of the first information and a coordinate system (map coordinate system) of the second information, for example, the information integration portion 36 sets the map coordinate system as the predetermined reference coordinate system. For example, first, in the region where the first information is effective, the information integration portion 36 converts the world geographical coordinate system of the first information into the map coordinate system in accordance with a correspondence relationship between the origin (a measurement start point of the point group map or the like) of the map coordinate system and a coordinate value of the world geographical coordinate system. Then, the information integration portion 36 acquires the inter-coordinate difference by performing a predetermined optimization process in a region where a combination of the first information and the second information recognized as the information at the same time can be obtained, in the region where the first information is not effective and the part of the region where the first information is effective.

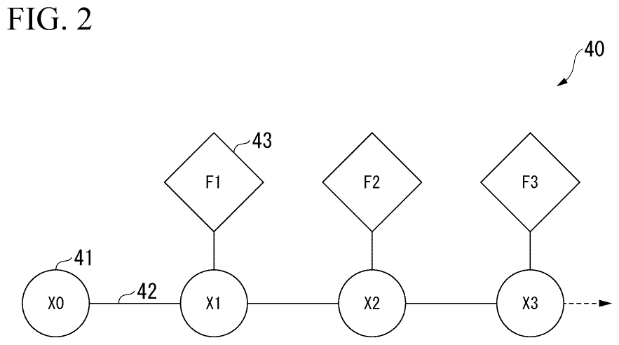

FIG. 2 is a view showing an example of a pose graph 40 formed by the position measurement apparatus 20 of the embodiment.

As shown in FIG. 2, the information integration portion 36 acquires the inter-coordinate difference, for example, by the optimization process of the pose graph 40. The pose graph 40 includes, for example, a plurality of nodes 41, a plurality of edges 42, and a plurality of observation amounts 43. The plurality of nodes 41 indicate, for example, information (position attitudes X0, X1, X2, X3 . . . ) of a plurality of positions, attitudes, and the like of the movable body M obtained in a time series. The plurality of edges 42 connect, for example, the nodes 41 adjacent to each other in the time series. The plurality of edges 42 relatively constrain, for example, the adjacent nodes 41 by a plurality of first information obtained in the time series. The plurality of observation amounts 43 absolutely constrain, for example, each node 41 by each of a plurality of second information (second information F1, F2, F3 . . . ) obtained in the time series.

For example, the information integration portion 36 acquires the inter-coordinate difference by sequentially performing the optimization process at each time when the combination of the first information and the second information is obtained. The information integration portion 36 calculates a coordinate conversion matrix that converts the world geographical coordinate system into the map coordinate system (predetermined reference coordinate system) in accordance with the inter-coordinate difference acquired by the optimization process. The information integration portion 36 converts the first information by using the coordinate conversion matrix.

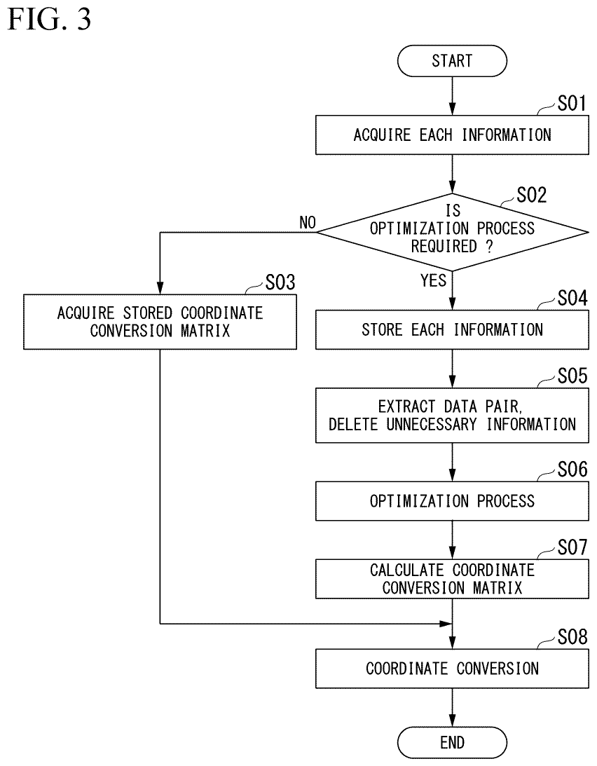

FIG. 3 is a flowchart showing an operation of the position measurement apparatus 20 in the embodiment.

First, in Step S01 shown in FIG. 3, the information integration portion 36 acquires each of the first information, the second information, and the third information.

Next, in Step S02, the information integration portion 36 determines whether or not it is necessary to perform the optimization process for the first information and the second information. When the determination result is “NO”, the information integration portion 36 advances the process to Step S03. On the other hand, when the determination result is “YES”, the information integration portion 36 advances the process to Step S04.

Next, in Step S03, the information integration portion 36 acquires a coordinate conversion matrix with respect to each of the first information and the second information stored in the storage portion 12 of the server 10, the storage portion 26 of the position measurement apparatus 20, or the like in advance. Then, the information integration portion 36 advances the process to Step S06 described later.

Further, in Step S04, the information integration portion 36 stores each of the acquired first information, the acquired second information, and the acquired third information, for example, in the storage portion 26 of the position measurement apparatus 20, the storage portion 12 of the server 10, or the like.

Next, in Step S05, the information integration portion 36 extracts a combination (data pair) of the first information and the second information recognized as information at the same time, for example, from the respective information stored in the respective storage portions 26, 12 and the like. The information integration portion 36 deletes unnecessary information other than the data pair, for example, among the respective information stored in the respective storage portions 26, 12, and the like.

Next, in Step S06, the information integration portion 36 acquires the inter-coordinate difference by performing the optimization process.

Next, in Step S07, the information integration portion 36 calculates the coordinate conversion matrix in accordance with the inter-coordinate difference acquired by the optimization process.

Next, in Step S08, the information integration portion 36 performs coordinate conversion by using the coordinate conversion matrix. Then, the information integration portion 36 advances the process to the end.

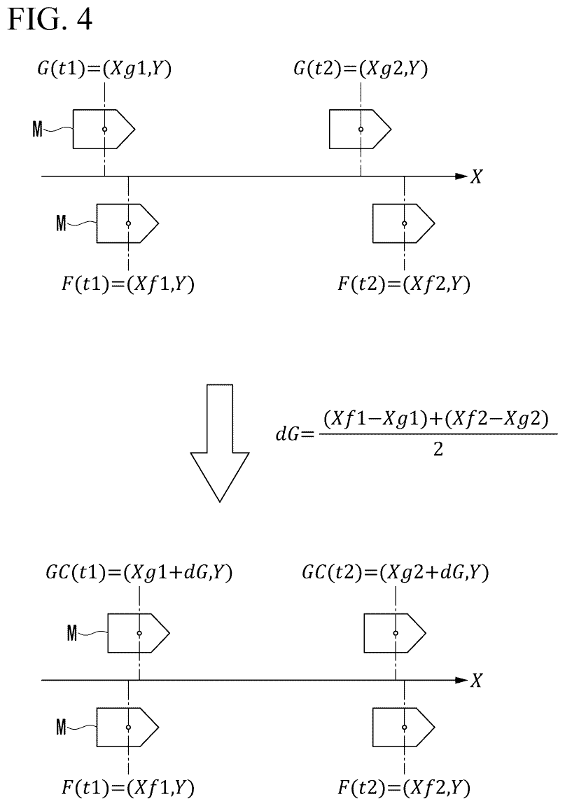

FIG. 4 is a view schematically showing an example of the optimization process by the position measurement apparatus 20 of the embodiment.

In an example shown in FIG. 4, the position of the movable body M is defined by a two-dimensional orthogonal coordinate system having an X-axis and a Y-axis, and the movable body M moves along the X-axis direction from a time t1 to a time t2. A combination recognized as information at the same time in the time t1 is a combination of a position G (t1) by the first information and a position F (t1) by the second information at the time t1. A combination recognized as information at the same time in the time t2 is a combination of a position G (t2) by the first information and a position F (t2) by the second information at the time t2.

The information integration portion 36 performs a predetermined optimization process, for example, so as to minimize the difference between the first information and the second information at each of the time t1 and the time t2. An inter-coordinate difference dG obtained by the optimization process is, for example, an average value of the difference between the position G (t1) and the position F (t1) at the time t1 and the difference between the position G (t2) and the position F (t2) at the time t2.

The information integration portion 36 corrects, for example, each of the position G (t1) and the position G (t2) of the first information by the inter-coordinate difference dG and thereby acquires a position GC (t1) and a position GC (t2) after the correction.

As described above, according to the position measurement apparatus 20 and the position measurement method of the embodiment, by including the information integration portion 36 that corrects the difference between the different coordinate systems (the world geographical coordinate system and the map coordinate system) of the first position estimation portion 31 and the second position estimation portion 33, it is possible to acquire the position information of the movable body M with high accuracy. In this way, when improving robustness with respect to the motion environment of the movable body in a plurality of position measurement portions, that is, when improving robustness with respect to the motion environment of the movable body M in the first position estimation portion 31 and the second position estimation portion 33, even when non-uniform distortion is present in each coordinate system, it is possible to perform appropriate coordinate conversion.

By including the information integration portion 36 that corrects, with respect to the combination of the first information and the second information recognized as information at the same time, the position difference caused by the time difference by inertial navigation, even when the first information and the second information output from the first position estimation portion 31 and the second position estimation portion 33 are asynchronous, it is possible to cause the first information and the second information to appropriately correspond with respect to the time.

The information integration portion 36 sets the map coordinate system to the predetermined reference coordinate system, and thereby, for example, even when an accuracy decrease, reception difficulty, or the like of the position measurement signal occurs depending on the motion environment of the movable body M, it is possible to acquire the position information of the movable body M with high accuracy.

By including the point group process portion 32 that generates the point group map by the point group data at least in the region (the region where the first information is not effective) where the position measurement by the first position estimation portion 31 is not performed, for example, even when the operation of the point group process portion 32 and the second position estimation portion 33 become complicated or complex in response to a frequent change or the like of the motion environment of the movable body M, it is possible to reduce a dependence degree on the second position estimation portion 33.

### Modification Example

Hereinafter, modification examples of the embodiment are described. The same parts as those of the embodiments described above are denoted by the same reference numerals, and description thereof are omitted or simplified.

The above embodiment is described using an example in which the information integration portion 36 acquires the inter-coordinate difference by the optimization process of the pose graph 40; however, the embodiment is not limited thereto. For example, the information integration portion 36 may acquire the inter-coordinate difference by another optimization process such as an extended Kalman filter.

The above embodiment is described using an example in which the information integration portion 36 uses the map coordinate system as the predetermined reference coordinate system; however, the embodiment is not limited thereto. For example, coordinate systems other than the world geographical coordinate system and the map coordinate system may be used as the predetermined reference coordinate system. The information integration portion 36 may convert each coordinate system to the predetermined reference coordinate system, for example, by using a coordinate conversion matrix set for each of the first information and the second information.

The above embodiment is described using an example in which the information integration portion 36 calculates the coordinate conversion matrix; however, the embodiment is not limited thereto. The information integration portion 36 may acquire a coordinate conversion matrix calculated at an appropriate position by the position measurement apparatus 20 provided on another movable body. The coordinate conversion matrix calculated by the position measurement apparatus 20 of the other movable body may be stored, for example, in the storage portion 12 of the server 10 or the like.

The above embodiment is described using an example in which the position measurement apparatus 20 includes the position measurement signal reception portion 22 and the object detection portion 23; however, the embodiment is not limited thereto. For example, the position measurement apparatus 20 may include another device that outputs detection information relating to the information of the position, the attitude, and the like of the movable body M such as a camera. The information integration portion 36 may acquire the inter-coordinate difference by using the information of the position, the attitude, and the like of the movable body M acquired based on the detection information output from the other device.

In the embodiment described above, all or some of the processes performed by the process part 27 of the position measurement apparatus 20 may be performed by the process part 13 of the server 10.

A program for realizing all or some of the functions of the position measurement system 1 in the embodiment of the present invention may be recorded in a computer-readable recording medium, the program recorded in the recording medium may be read into and executed by a computer system, and thereby, all or some of the processes performed by the position measurement system 1 may be performed. It is assumed that the term “computer system” used herein includes an OS or hardware such as peripherals. It is also assumed that the term “computer system” includes a WWW system which includes a homepage-providing environment (or a display environment). The term “computer-readable recording medium” refers to a portable medium such as a flexible disk, a magneto-optical disk, a ROM, and a CD-ROM and a storage device such as a hard disk embedded in the computer system. It is also assumed that the term “computer-readable recording medium” includes a medium which holds a program for a given time such as a volatile memory (RAM) in the computer system which becomes a server or a client when a program is transmitted through a network such as the Internet or a communication line such as a telephone line.

The program may be transmitted from the computer system which stores the program in the storage device or the like, to another computer system through a transmission medium or through transmission waves in the transmission medium. The term “transmission medium” which transmits the program refers to a medium having a function of transmitting information that is, for example, a network (communication network) such as the Internet or a communication line such as a telephone line. The program may be a program for realizing some of the above-described functions. The program may be a so-called differential file (differential program) which can realize the above-described functions by a combination with a program already recorded in the computer system.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and gist of the invention and are also included within the scope of the invention described in the appended claims and equivalents thereof.

What is claimed is:

1. A position measurement apparatus, comprising:
a plurality of different position measurement portions that output position information of a movable body based on a position measurement in each of a plurality of different coordinate systems; and
a process portion that acquires a difference relating to the position information between the plurality of different coordinate systems based on a combination of the position information corresponding to a predetermined time among the position information output from the plurality of different position measurement portions and acquires position information of the movable body in a predetermined reference coordinate system by correcting the difference.

2. The position measurement apparatus according to claim 1, comprising:
an inertial navigation process portion that processes inertial navigation based on inertia information output from an inertia detection portion provided on the movable body,
wherein the process portion corrects a position difference caused by a time difference from the predetermined time in the position information corresponding to the predetermined time by the inertial navigation by the inertial navigation process portion.

3. The position measurement apparatus according to claim 2,
wherein the plurality of different position measurement portions comprise a first position measurement portion and a second position measurement portion,
the first position measurement portion outputs the position information by a position measurement based on a position measurement signal acquired from an outside,
the second position measurement portion outputs the position information by a position measurement based on point group information obtained in accordance with detection of an external object, and
the process portion sets the coordinate system of the second position measurement portion to the predetermined reference coordinate system.

4. The position measurement apparatus according to claim 3,
wherein the second position measurement portion generates a map by the point group information at least in a region where the position measurement by the first position measurement portion is not performed.

5. A position measurement method executed by an electronic device including a process part that acquires position information of a movable body, the position measurement method comprising:
outputting position information of the movable body by a position measurement in each of a plurality of different coordinate systems; and
acquiring a difference relating to the position information between the plurality of different coordinate systems based on a combination of the position information corresponding to a predetermined time among the output position information and acquiring position information of the movable body in a predetermined reference coordinate system by correcting the difference.

6. A computer-readable non-transitory recording medium that includes a program causing a computer of an electronic device including a process part that acquires position information of a movable body to execute:
outputting position information of the movable body by a position measurement in each of a plurality of different coordinate systems; and
acquiring a difference relating to the position information between the plurality of different coordinate systems based on a combination of the position information corresponding to a predetermined time among the output position information and acquiring position information of the movable body in a predetermined reference coordinate system by correcting the difference.

7. A computer-readable storage device that stores the program according to claim 6.
